(19) United States
(12) Patent Application Publication
(10) Pub. No.: US 2021/0187824 A1
(43) Pub. Date: Jun. 24, 2021

(54) CRAFTING MEDIUM CONTAINING A WATER-BASED BINDER COMPOSITION FOR THREE-DIMENSIONAL PRINTING

(71) Applicants: ADDLEAP AB, Gothenburg (SE); DESKTOP METAL, INC., Burlington, MA (US)

(72) Inventors: Mats MOOSBERG, Gothenburg (SE); Alexander C. BARBATI, Burlington, MA (US)

(21) Appl. No.: 17/052,806

(22) PCT Filed: May 3, 2019
(86) PCT No.: PCT/US2019/030709

§ 371 Date: Nov. 4, 2020

Related U.S. Application Data
(60) Provisional application No. 62/666,719, filed on May 4, 2018.
(60) Provisional application No. 62/666,796, filed on May 4, 2018.
(60) Provisional application No. 62/666,798, filed on May 4, 2018.
(60) Provisional application No. 62/668,281, filed on May 8, 2018.
(60) Provisional application No. 62/668,279, filed on May 8, 2018.
(60) Provisional application No. 62/676,331, filed on May 25, 2018.

(51) Int. Cl. B29C 64/118; B28B 1/00; B22F 10/20

(52) U.S. Cl. CPC B29C 64/118; B33Y 10/00; B22F 10/20; B28B 1/001

(57) ABSTRACT

This invention relates to a three-dimensional printing. This invention in particularly relates to a crafting medium containing water-based binder for three dimensional printing. The present invention also relates to a system for making three-dimensional object and a method thereof. The three-dimensional objects with a powder plus binder constitution for sintering there are several problems, the binder is difficult to remove because it needs to be dissolved or burned out after the object is finished. The binder can also be hazardous and needs toxic substances to dissolve. While removing the binder there is a risk for cracks and deformities in the resulting object. The crafting medium which is in the paste form includes 40 volume %-80 volume % metal/ceramic powder, 1 volume %-5 volume % gelling organic material, and 15 volume %-60 volume % water. Also additional corrosion inhibitors, sintering aiding or lubrication additives in the range of 0.1-2 volume % can be added. The water-binder in the crafting medium is removed after deposition of each layer. During the three-dimensional printing around 60-90% of the water is removed during layer-by-layer deposition. This leaves a porous structure that still has some binder to keep the object rigid, but binder contents is small enough and object is porous enough to allow for sintering without a separate debinding step in post processing.

### FIELD OF THE INVENTION

The present invention generally relates to the field of three-dimensional (“3D”) printing of objects based on crafting and molding techniques. The invention, particularly relates to a crafting medium containing aqueous or aqueous-based binder compositions for three dimensional printing. The present invention also relates to a system for making three-dimensional object and a method thereof.

### BACKGROUND OF THE INVENTION

Three-dimensional printers are used to build solid models by performing layer by layer printing of a building material. The building material can be of different forms, such as a liquid or a semiliquid at the three-dimensional printhead. For example, a solid material can be heated and then extruded from a three-dimensional printer nozzle. The layers of building materials can be solidified on a substrate. Three-dimensional printer systems can use a fused filament fabrication (FFF) process (sometimes called fused deposition modeling (FDM) process) in which a filament is moved by a filament moving mechanism, toward a heated zone. The filament can be melted and extruded on a platform to form a three-dimensional object. The melted filament can adhere to the walls of the heated printhead, resulting in deformed printed lines. A commercially available FFF system uses a heated nozzle to extrude a melted material such as a plastic wire. The starting material is in the form of a filament which is being supplied from a spool. The filament is introduced into a flow passage of the nozzle and is driven to move like a piston inside this flow passage. The front end, near the nozzle tip, of this piston is heated to become melted. The rear end or solid portion of this piston pushes the melted portion forward to exit through the nozzle tip. The nozzle is translated under the control of a computer system in accordance with previously generated computer-aided design (“CAD”) data that has been sliced into constituent layers.

A number of different types of compositions for three-dimensional printing are available in the prior art. For example, the following patents are provided for their supportive teachings and are all incorporated by reference:

U.S. Pat. No. 5,121,329 to S Scott Crump discloses an apparatus for making three-dimensional physical objects of a predetermined shape by sequentially depositing multiple layers of a solidifying material on a base member in a desired pattern. The reference does not appear to disclose the formation of a mold or the use of any crafting medium.

Another prior art document, WO2002045889 to Bredt et al. describes a composition having an acid and/or base additive that increases the solids loading potential of the composition and a process for forming injection molded articles therefrom. Increasing the solids loading potential of the composition, enables the formation of metal or ceramic articles having improved dimensional stability and prevents significant cracking or shrinking during the part drying and sintering processes. However, the reference does not appear to disclose either an organic binding material or the formation of a mold or use of any crafting medium.

Yet another prior art document, U.S. Pat. No. 5,286,767 to Rohrbach et al discloses modified agar and processes for preparing a modified agar for use in a ceramic composition to add green strength and/or to improve other properties of a preform. Gel-forming compositions, such as agar, with a gel-enhancing agent, e.g. polyethyleneimine, are disclosed. The gel-forming compositions are disclosed to provide an improved ceramic molding process and/or the ceramic products formed therefrom. However, this prior art document does not appear to discuss a three-dimensional printing method or system thereof.

Yet another prior art document, U.S. Pat. No. 6,262,150 to Behi et al discloses a composition and a process for forming sintered, molded articles having improved dimensional stability. More particularly, this invention pertains to a composition having a sugar additive that increases the solids loading potential of the composition and a process for forming injection molded articles therefrom. The reference discloses that increasing the solids loading potential of the composition, enables the formation of metal or ceramic articles attaining about 98-99% of the theoretical maximum density, without cracking or shrinking significantly during sintering. The composition also includes agaroid. However, this prior art document does not appear to discuss either the layer-by-layer deposition; the formation of a mold layer, or the use of any crafting medium.

Yet another prior art document, U.S. Pat. No. 6,008,281 to Yang et al discloses a powder injection molding composition or feedstock made of 70% or more by weight of a powdered metal or ceramic and 30% or less by weight of a binder system. The binder system contains polypropylene or polyethylene to hold the so-called brown preform of the molded metal or ceramic powder together for the sintering step of the injection molding process, and a partially hydrolyzed cold water-soluble polyvinyl alcohol, water, and a plasticizer to facilitate molding of the composition into the so-called green preform of the article to be manufactured. However, this prior art document does not appear to discuss layer-by-layer deposition; formation of a mold layer, or use of any crafting medium.

Yet another prior art document, U.S. Pat. No. 6,770,114 to Bartone et al discloses a powder for metal injection molding having a silicon content of less than 0.1% and silica inclusions, which are substantially eliminated in the finished molded product. However, this prior art document does not appear to discuss layer-by-layer deposition; the formation of mold layer, or use of any crafting medium.

Yet another prior art documents, U.S. Pat. Nos. 9,833,839 and 9,815,118 both discloses similar techniques for fabricating support structures, breakaway layers, and the like suitable for use with sinterable build materials. A furnace or heating device is used at the post-processing steps and/or for sintering into a densified object. Further, the system is described in some embodiments to also include a temperature control system at the build plate for fabricating the object. However, these prior art documents do not appear to discuss the drying of the second material or second binder (which is the crafting medium) by heating or by air.

Yet another prior art document, U.S. Pat. No. 8,475,946 to Dion et al discloses a method of preparing a ceramic precursor article, the ceramic precursor made thereby, a method of making a ceramic article and an article made by that method. It also includes a method of replicating a ceramic shape. This prior art document describes that one of the main challenges of the use of ceramic products with modern technologies is its reduction factor (shrinkage). Depending on the processes used, drying, firing or hot pressing of a ceramic object can cause shrinkage as high as 20 percent. Such shrinkage can cause a significant problem if the nature of the ceramic article requires precise dimensional control.

Yet another prior art document, US20110129640 to Beall et al discloses a method for making porous articles, including: depositing a powder mixture layer comprising a binder powder, and at least one structural powder; contacting the powder mixture layer and an aqueous liquid to selectively activate the binder powder and form a green layer; repeating the depositing and the contacting sequence at least one time; and de-powdering and drying of the resulting green body. In this prior art document, the drying is carried out at the end of the processing. This document fails to discuss the drying of finished layers by heating or by air.

Yet another prior art document, US20170246760 to Colombo discloses binder for the additive production of manufactured items, in particular made of conglomerate, adapted to be distributed on a layer of inert granular material in order to form a rigid matrix incorporating the granules of the inert granular material. The binder according to the invention is a substantially inorganic hydraulic binder with magnesium phosphate cement base. The reference does not appear to disclose the formation of mold or use of any crafting medium.

Yet another prior art document, WO2015171639 to Bredt et al discloses a method for forming a three-dimensional article includes providing a layer of a powder mixture including a soluble adhesive, magnesium oxide, an acid additive, and a nonreactive ceramic filler; and applying a substantially nonaqueous liquid jetting fluid including less than 50% water by weight to the powder mixture layer. The reference does not appear to disclose the formation of mold or use of any crafting medium.

Yet another prior art document, US20010050031 to Bredt et al discloses a three-dimensional printing materials system and method can produce both appearance models and small numbers of functional parts in an office environment. The method can include building cross-sectional portions of a three-dimensional article, and assembling the individual cross-sectional areas in a layer-wise fashion to form a final article. The reference does not appear to disclose the formation of mold or use of any crafting medium.

Yet another prior art document, SE1500245 to Mats Moosberg discusses a three-dimensional imaging process for making objects, preferably metal objects or ceramic objects, on a layer-by-layer basis under the control of a data processing system. The process also includes the use of a filament material (in the form of a solid that melts to a fluid during the printing process) to build the mold and a crafting medium (in the form of paste) for filling the hollow mold cavity. The method for building the three-dimensional model by extruding a crafting medium in parallel with a molding material as described in the prior art document, SE1500245, requires that the crafting medium paste is dried after the creation of the object. The drying process is evacuating all water from the paste and leave a dry “green body”, similar to dried clay. The problem which needs to be addressed here is that the paste needs to be dried evenly to avoid cracks. It is also important that the paste is dried fully in the middle to avoid problems in the next steps.

However, the above mentioned references and many other similar references have one or more of the following shortcomings: (a) discussing injection molding technique; (b) not discussing the use of a building or crafting medium; (c) prior art three-dimensional-printing method use of a powder clay which is mixed with water and printed out on a layer by layer basis using a syringe to obtain ceramic objects; (d) when crafting objects using a powder and binder constitution mixture for sintering then the binder is difficult to remove because it needs to be dissolved or burned out after the three-dimensional object is prepared; (e) the binder can also be hazardous and needs toxic substances to dissolve; (f) ceramic object may have low resolution; (g) finishing of the final three-dimensional printed object is not good; and (h) none of the references discusses a composition of the crafting medium or building material containing binder materials and water.

A solution to this problem is achieved by the present invention which provides a novel craft medium composition containing a very low concentration of the binder organic base materials, such as cellulose, cellulose derivatives, agar, etc., and from about 15 to 60 volume % water. The binding organic base material content can be varied from 1 to 10 volume %. The binder can act as glue between the powder particles, and also as filler between the particles. The compositions comprise relatively high amounts of metal or ceramic powders, e.g. from about 40% to about 80% by volume basis of the powder, which provides for good density and less shrinkage during sintering.

The method of preparation of three-dimensional object also includes the step of drying layer-by-layer. The de-binding is a continuous process in the present invention and remove majority of the water from the binder composite material from each layer after depositing. The use of novel paste or craft medium composition and the method of the present invention are eliminating the post-processing step of binder removal.

The present application addresses the above-mentioned concerns and short comings with regard to providing a novel craft medium composition comprising binder organic base material and water. Further, the system of preparing three-dimensional object and a method thereof is also disclosed.

### SUMMARY OF THE INVENTION

The present invention relates to a three-dimensional printing and in particular to a crafting medium containing water-based binder. The crafting medium comprises a relatively high level, on a volumes basis, of a metal or ceramic powder, with relatively low levels, on a volumes basis, of a binder and an aqueous solvent. The crafting medium is useful for three-dimensional printing of metal and ceramic objects and can be used in a printing process where the aqueous solvent system is continuously removed as each layer of the crafting medium is printed.

The present invention relates to a crafting medium for three-dimensional printing of a metallic or ceramic object comprising:
(a) from about 40% to about 80% by volume basis of a powder selected from metal powders, ceramic powders, and combinations, thereof;
(b) from about 0.5% to about 10% by volume of a binder; and
(c) from about 15% to about 60% by volume of an aqueous solvent.

In further embodiments the present invention relates to a medium wherein the aqueous solvent is selected from water, or water in combination with one or more water-miscible solvents.

In further embodiments the present invention relates to a medium wherein the powder has a particle size from about 0.1 to about 100 microns.

In further embodiments the present invention relates to a medium wherein said water miscible solvent is selected from C1-C3 alcohols, C2-C4 diols, glycerol, acetonitrile, acetone, ethyl acetate, and combinations thereof.

In further embodiments the present invention relates to a medium wherein said metal powder is selected from silver, gold, copper, tin, nickel, chromium, zinc, tungsten, cobalt, aluminum, molybdenum, boron, iron, titanium, vanadium, niobium, silicon, manganese, steel, metal alloys or combinations thereof.

In further embodiments the present invention relates to a medium wherein said ceramic powder is selected from silicon carbide, boron carbide, aluminum carbide, tungsten carbide, titanium carbide, tantalum carbide, silicon nitride, boron nitride, aluminum nitride, titanium nitride, zirconium nitride, steatite, forsterite, alumina, zircon beryllia, magnesia, mullite, cordierite, aluminum titanate, zirconia, and combinations thereof

In further embodiments the present invention relates to a medium wherein the binder is selected from organic binds, inorganic binders, and combinations thereof.

In further embodiments the present invention relates to a medium wherein the in organic binder is selected from epoxy, polyurethane, agar-agar, starch, cellulosic materials, arrow root, Agar (E406), Alginic acid (E400), Sodium alginate (E401), Carrageenan (E407), Gum arabic (E414), Gum ghatti, Gum tragacanth (E413), Karaya gum (E416), Guar gum (E412), Locust bean gum (E410), Beta-glucan, Chicle gum, Dammar gum, Glucomannan (E425), Mastic gum, Psyllium seed husks, Spruce gum, Tara gum (E417), Gellan gum (E418), Xanthan gum (E415), polyethylene oxide, polycarboxylic acids (polyacrylic acid), polycarboxylate ethers, polyvinyl alcohol, cellulose gum (Aquacel GSA and Aquacel GSH), hydroxymethyl cellulose, hydroxypropyl cellulose, carboxymethyl cellulose, styrene-butadiene rubber, and combinations thereof.

In further embodiments the present invention relates to a medium wherein the inorganic binder is selected magnesium oxide, magnesic, cement, sorel cement, inorganic salts, and combinations thereof.

In further embodiments the present invention relates to a medium comprising:

(a) from about 60% to about 70% by volume basis of a powder;
(b) from about 1% to about 5% by volume of a binder; and
(c) from about 25% to about 35% by volume of an aqueous solvent.

In further embodiments the present invention relates to a medium further comprising from about 0.1% to about 2% by volume of one or more additives selected from corrosion inhibitors, sintering aids, viscosity modifier, and lubricants.

In further embodiments the present invention relates to a medium wherein said corrosion inhibitor is selected from lithium nitrate, sodium nitrate, potassium nitrate, calcium nitrate, magnesium nitrate, zinc nitrate, cobalt nitrate, iron nitrate, chromium nitrate, copper nitrate, lithium nitrite, sodium nitrite, potassium nitrite, calcium nitrite, magnesium nitrite, zinc nitrite, and mixtures thereof.

In further embodiments the present invention relates to a medium wherein said sintering aid is selected from salts, gum rosin, pine rosin, isopropyl alcohol, propylene glycol, metal oxides, low-melting point metals, alkaline earth metals, and mixtures thereof.

In further embodiments the present invention relates to a medium wherein said lubricant is selected from essential oils, glycerin, metal stearate salts, carbon black, silica, ferric oxides, and combinations thereof.

In further embodiments the present invention relates to an extrusion layer for three-dimensional printing of a metallic or ceramic object comprising:

(I) a crafting medium, comprising:
(a) from about 40% to about 80% by volume basis of a powder selected from metal powders, ceramic powders, and combinations, thereof;
(b) from about 0.5% to about 10% by volume of a binder; and
(c) from about 15% to about 60% by volume of an aqueous solvent;
and
(II) a mold layer for containing said crafting medium, comprising a polymeric molding material;
wherein said mold layer substantially contains said crafting medium.

In further embodiments the present invention relates to an extrusion layer wherein said polymeric molding material is selected from the group consisting of poly(propylene), poly(styrene), poly(lactic acid) (PLA), acrylonitrilebutadiene-styrene (ABS), polycarbonate abs (PC-ABS), nylon, poly(carbonate), poly(phenyl sulfone), ultem, poly(ethylene), acrylic [poly(methyl methacrylate)], poly(benzimidazole), poly(ether sulfone), poly(etherether ketone), poly(etherimide), poly(phenylene oxide), poly(phenylene sulfide), poly(vinyl chloride), poly(vinyldiene fluoride), poly(acetal), poly(vinyl acetate), poly(vinyl butyrate), poly(vinyl alcohol), poly(4-hydroxystyrene), poly(vinyl formate), poly(vinyl stearate), poly(acrylamide), poly(caprolactone), chitosan and combinations thereof.

In further embodiments the present invention relates to an extrusion layer prior to sintering.

In further embodiments the present invention relates to a medium a method of making a crafting medium for three-dimensional printing of a metallic or ceramic object comprising:

(a) from about 40% to about 80% by volume basis of a powder selected from metal powders, ceramic powders, and combinations, thereof;
(b) from about 0.5% to about 10% by volume of a binder; and
(c) from about 15% to about 60% by volume of an aqueous solvent, comprising the steps of:
(i) dissolving the binder in the aqueous solvent with stirring and heating to obtain a solution; and
(ii) mixing the powder with the solution obtained from step (i) with stirring to yield a crafting medium suitable for three-dimensional printing of a metallic or ceramic object.

In further embodiments the present invention relates to a wherein said crafting medium comprises
(a) from about 60% to about 70% by volume basis of a powder;
(b) from about 1% to about 5% by volume of a binder; and
(c) from about 25% to about 35% by volume of an aqueous solvent.

In further embodiments the present invention relates to a crafting medium for three-dimensional printing of a metallic or ceramic object comprising:
(a) from about 40% to about 80% by volume basis of a powder selected from metal powders, ceramic powders, and combinations, thereof;
(b) from about 0.5% to about 10% by volume of a binder; and
(c) from about 15% to about 60% by volume of a non-aqueous solvent.

In further embodiments the present invention relates to a method wherein said non-aqueous solvent is selected from the group consisting of methanol, ethanol, 1-propanol, 2-propanol, acetone, acetaldehyde, ethyl acetate, C2-C4 diols, glycerol, acetonitrile, C4-alcohols, 2-ethoxyethanol, 2-ethyl hexanol, 1,2-dichloroethane, diisopropyl amine, isoamyl alcohol, propyl acetate, isopropyl acetate, and mixtures thereof. Also, contemplated are azeotropes.

### BRIEF DESCRIPTION OF THE DRAWINGS

The invention will be better understood and objects other than those set forth above will become apparent when consideration is achieved to the following detailed description thereof. Such description makes reference to the annexed drawings wherein:

FIG. 1 depicts a schematic representation of the system in accordance with the present invention.

FIG. 2 illustrates by a flow chart an example of a method for drying a paste-based crafting medium during three-dimensional printing.

FIG. 3 illustrates a structured layered during three-dimensional printing in accordance with the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense.

Three-dimensional printing is a process of constructing three-dimensional objects from digitized files. In this process, a three-dimensional object is designed using SolidWorks, AutoCAD, and Z-Brush, which are some examples of popular CAD software used commercially. Meshmixer, SketchUP, Blender, and FreeCAD, are some examples of the freeware commonly used to make three-dimensional objects. These three-dimensional objects are saved in a three-dimensional printer-readable file format. The most common universal file formats used for three-dimensional printing are STL (stereolithography) and VRML (virtual reality modeling language). Additive manufacturing file format (AMF), GCode, and ×3 g are some of the other three-dimensional printer readable file formats. In additive manufacturing, material is laid in layer-by-layer fashion in the required shape, until the object is formed. Although the term three-dimensional printing is used as a synonym for additive manufacturing, there are several different fabricating processes involved in this technology. Depending on the three-dimensional printing process, additive manufacturing can be classified into four categories, including extrusion printing, material sintering, material binding, and object lamination.

In the three-dimensional printing process it is required to use the crafting medium with binders to provide rigidity to the object while fabrication. Different types of binding materials are used in three-dimensional printing processes. Organic binders, such as epoxy, polyurethane, agar-agar, starch, cellulosic materials, Agar (E406), Alginic acid (E400), Sodium alginate (E401), Carrageenan (E407), Gum arabic (E414), Gum ghatti, Gum tragacanth (E413), Karaya gum (E416), Guar gum (E412), Locust bean gum (E410), Beta-glucan, Chicle gum, Dammar gum, Glucomannan (E425), Mastic gum, Psyllium seed husks, Spruce gum, Tara gum (E417), Gellan gum (E418), Xanthan gum (E415), polyethylene oxide, polycarboxylic acids (polyacrylic acid), polycarboxylate ethers, polyvinyl alcohol, cellulose gum (Aquacel GSA and Aquacel GSH), hydroxymethyl cellulose, hydroxypropyl cellulose, Carboxymethyl cellulose, styrene-butadiene rubber, etc. can be used while Inorganic binders, such as magnesium oxides, magnesic, cement, sorel cement, salts, etc. are used. The three-dimensional objects with a powder plus binder constitution for sintering there are several problems, the binder is difficult to remove because it needs to be dissolved or burned out after the object is finished. The binder can also be hazardous and needs toxic substances to dissolve. While removing the binder there is a risk for cracks and deformities in the resulting object. Further, method of three-dimensional printing using clay or ceramic materials and preparing molding is also well known in the prior art documents. Most of these prior art documents discusses the drying or heating of the mold or clay paste post processing. Main problem arises of cracking when drying is carried out at the end of the processing. It develops cracks and unevenness on the mold or on the object. The present invention is providing solution to solve the cracks and unevenness on the mold.

A solution to this problem is achieved in the present invention by providing a crafting medium comprising a metal or ceramic, binder organic base materials, and water. The crafting medium which is in the paste form comprises 40 volume %-80 volume % metal/ceramic powder, 1 volume %-10 volume % organic base material, and 15 volume %-60 volume % of an aqueous solvent. In another embodiment, the crafting medium comprises 60 volume %-70 volume % metal/ceramic powder, 1 volume %-5 volume % organic base material, and 25 volume %-35 volume % of an aqueous solvent. The metal or ceramic powder particle size is in the range from 0.1-100 micrometers.

As distinguished from other methods, the three-dimensional printing methods of the present invention involve partial or complete, drying of a portion of all of a desired deposited layer of a crafting medium. This drying corresponds to removal of some or substantially all of the solvent or carrier component associated with the binder, which in some embodiments of the present invention is an aqueous solvent. The aqueous solvent can comprise water or water in combination with other solvents that are generally miscible with water at the concentrations or proportions utilized. In other embodiments, the solvent or carrier can be a nonaqueous material. The present invention generally leaves behind the binder in the deposited layer, which can be advantageous to maintain the structural integrity of the printed object prior to further processing.

In further embodiments the present invention relates to a method wherein said aqueous solvent is selected from water, methanol, ethanol, 1-propanol, 2-propanol, acetone, ethyl acetate, and combinations thereof.

In a preferred embodiment of the invention, the crafting medium consists of microscopic particles of metal, such as silver, gold, copper, tin, nickel, chromium, zinc, tungsten, cobalt, aluminium, molybdenum, boron, iron, titanium, vanadium, niobium, silicon, manganese, steel or alloys or combinations thereof, and also oxides from these metals, mixed with the binder organic base material and water. Also additional corrosion inhibitors, sintering aiding or lubrication additives in the range of 0.1-2 volume % can be added.

In another preferred embodiment, the powder is instead a ceramic powder such as silicon carbide, boron carbide, aluminum carbide, tungsten carbide, titanium carbide, tantalum carbide, silicon nitride, boron nitride, aluminum nitride, titanium nitride, zirconium nitride, steatite, forsterite, alumina, zircon beryllia, magnesia, mullite, cordierite, aluminum titanate and zirconia mixed with the binder organic base material and water. Also additional corrosion inhibitors, sintering aiding or lubrication additives in the range of 0.1-2 volume % can be added.

In both these preferred embodiments, the binder organic base material can be polyurethane, agar-agar, starch, cellulosic materials, Agar (E406), Alginic acid (E400), Sodium alginate (E401), Carrageenan (E407), Gum arabic (E414), Gum ghatti, Gum tragacanth (E413), Karaya gum (E416), Guar gum (E412), Locust bean gum (E410), Beta-glucan, Chicle gum, Dammar gum, Glucomannan (E425), Mastic gum, Psyllium seed husks, Spruce gum, Tara gum (E417), Gellan gum (E418), Xanthan gum (E415), polyethylene oxide, polycarboxylic acids (polyacrylic acid), polycarboxylate ethers, polyvinyl alcohol, cellulose gum (Aquacel GSA and Aquacel GSH), hydroxymethyl cellulose, hydroxypropyl cellulose, Carboxymethyl cellulose, or combinations thereof.

Sintering aids such as Salts, gum rosin or pine rosin, isopropyl alcohol, Propylene glycol, Copper oxides, other metal oxides, low melting point metals or alkaline earth metals can be used. Lubricants aids such as essential oils, glycerin, zinc stearate or other stearates, carbon black, silica and ferrous oxide can be used. Corrosion inhibitor such as from the group consisting of the nitrate of lithium, sodium, potassium, calcium, magnesium, zinc, cobalt, iron, chromium, and copper, and the nitrite of lithium, sodium, potassium, calcium, magnesium, zinc can be used.

Substantially, i.e. most of the water or solvent in the binder composite is removed immediately after deposition of each layer by use of the drying apparatus. Generally it is desired to remove about 60-90% by weight of the water or solvent. In other embodiments at least about 90% by weight of the water or solvent is removed, in yet other embodiments at least about 95% by weight of the water or solvent is removed, and in yet other embodiments at least about 99% by weight of the water or solvent is removed. This novel method of three-dimensional object building does not require the use of a post-processing debinding step. Further, the present invention also provides a system for drying a paste based crafting medium during three-dimensional printing and method thereof. The drying apparatus or the heating system is connected to the moving print head. This makes drying possible after finishing each layer of the object (both mold and paste), the print head can repeatedly scan the printed layer and apply heat and air circulation to improve drying in a controlled way.

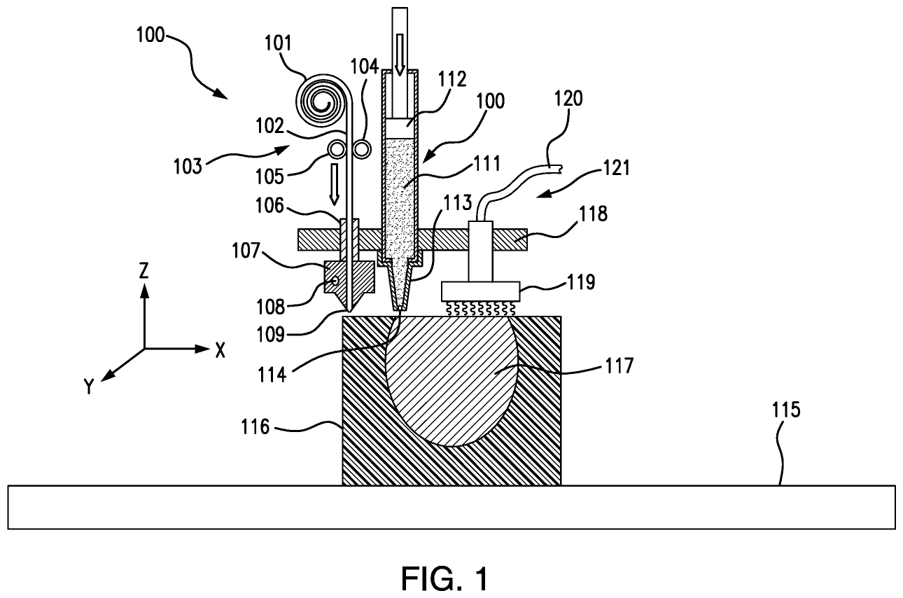

FIG. 1 depicts a schematic representation of the system for drying a paste based crafting medium during three-dimensional printing according to one of the embodiment of the present invention. The system 100 for drying paste based crafting medium during three-dimensional printing comprises: (a) supply arrangement for a filament material 101; (b) an extruder 103; (c) a feeding channel 106; (d) a plurality of nozzles 107 and 113; (e) a plurality of heating elements/systems 108 for melting the filament and 119 for drying the crafting medium; (f) a plurality of discharge orifices 109 and 114; (g) a supply arrangement for a crafting medium 110; (h) an actuator 112 for controlling the flow of the crafting medium; (i) a mold 116; and (j) a platform 115 on which the system of three-dimensional printer is fixed. The system has dual printhead which comprise a first dispensing nozzle 107 for depositing the filament 102 in flowable fluid form by the discharge orifice 109 to supply a filament 102 or a first material layer and a second dispensing nozzle 113 for depositing a crafting medium 111 or the second material layer which is in a paste form by the discharge orifice 114. The system further comprises a holding element 118 which holds a dual printhead and a heating element/system 119.

A filament feeding device comprising a stepper motor (not shown) and idler and driving rollers 104 and 105 located opposite to drive rollers which work together to grip the filament there between and to advance it through a filament feeding channel 106 thereby regulating the flow of filament through the feeding channel. The extruder 103 can be of any different type such as roller, gear system, etc. The heating system 119 can consist of a radiating heater, and possibly an air circulation fan. The heating system 121 may also have connectors 120, which can be of electric wire or pipes/tubes for blowing air. The heating system may also provide cooling or reducing the temperature and may behave as a temperature control system. Further, the temperature control system may include without limitation one or more of a heater, coolant, a fan, a blower, or the like.

As shown in the FIG. 1, a system 100 in accordance with a preferred embodiment of the present invention comprises a supply 101 of filament material such as acrylonitrilebutadiene-styrene (ABS) or Polylactic acid (PLA); a filament feeding device comprising a stepper motor (not shown), idler rollers 104 located opposite to drive rollers 105 which work together to grip the filament there between and to advance it through a filament feeding channel 106 thereby regulating the flow of filament through the feeding channel 106. The feeding channel 106 is made of a material having low thermal conductivity, such as for example Teflon. The system further includes a first dispensing nozzle 107 preferably made of a material with a thermal conductivity greater than 25 W/(m·K), such as for example brass or similar metallic alloys. The first dispensing nozzle 107 can be heated to a temperature sufficiently high for the filament 102 to liquify. Heating elements 108, in the form of a resistance heating tape or sleeve, and a temperature sensor (not shown) are arranged around a lower portion of the nozzle 107 to regulate the temperature of the nozzle 107 to a temperature of approximatively 200° C. to 240° C. in order to convert a leading portion of the filament 102 into a flowable fluid state. The solid (un-melted) portion of the filament 102 inside the feeding channel 106 acts like a piston to drive the melted liquid for dispensing through a first discharge orifice 109. The drive motor (not shown) can be controlled to regulate the advancing rate of the filament 102 in the feeding channel 106 so that the volumetric dispensing rate of the fluid can be closely controlled.

As shown in the FIG. 1, the apparatus further includes a supply 110 of crafting medium 111, such as for a novel composition. The novel composition of the present invention comprises metal/ceramic material, binder material, and water. The binder organic base material can be cellulose, agar-agar, starch, cellulosic materials, Agar (E406), Alginic acid (E400), Sodium alginate (E401), Carrageenan (E407), Gum arabic (E414), Gum ghatti, Gum tragacanth (E413), Karaya gum (E416), Guar gum (E412), Locust bean gum (E410), Beta-glucan, Chicle gum, Dammar gum, Glucomannan (E425), Mastic gum, Psyllium seed husks, Spruce gum, Tara gum (E417), Gellan gum (E418), polyethylene oxide, polycarboxylic acids (polyacrylic acid), polycarboxylate ethers, polyvinyl alcohol, Xanthan gum (E415), cellulose gum (Aquacel GSA and Aquacel GSH), hydroxymethyl cellulose, hydroxypropyl cellulose, Carboxymethyl cellulose, polyurethane, or any similar water soluble binding material. The crafting medium which is in the paste form includes 40 volume %-80 volume % metal/ceramic powder, 1 volume %-10 volume % organic base material, 15 volume %-60 volume % water, and 0.1 volume %-2 volume % additives. In a preferred embodiment of the invention, the crafting medium 111 consists of microscopic metal particles of metal, such as silver, gold, copper, tin, nickel, chromium, zinc, tungsten, cobalt, aluminium, molybdenum, boron, iron, titanium, vanadium, niobium, silicon, manganese, steel or alloys or combinations thereof, and also oxides from these metals, mixed with the binder organic base material and water. Also additional corrosion inhibitors, sintering aiding or lubrication additives in the range of 0.1-2 volume % can be added. The supply 110 is preferably shaped as a conventional clay extruder comprising a cylindrical cavity and valve means 112 to control and regulate the flow of crafting medium toward a second dispensing nozzle 113 and through a second discharge orifice 114.

In an alternate preferred embodiment, the powder is instead a ceramic powder such as silicon carbide, boron carbide, aluminum carbide, tungsten carbide, titanium carbide, tantalum carbide, silicon nitride, boron nitride, aluminum nitride, titanium nitride, zirconium nitride, steatite, forsterite, alumina, zircon beryllia, magnesia, mullite, cordierite, aluminum titanate and zirconia mixed with the binder organic base material and water. Also additional corrosion inhibitors, sintering aiding or lubrication additives in the range of 0.1-2% can be added.

Both nozzles 107 and 113 are arranged at a predetermined distance from an object supporting platform 115. The dual printhead and the platform 115 are moved relative to one another in a movement pattern corresponding to a predetermined object 117. The fused filament is deposited through the first discharge orifice 109 while the dual printhead is moving in an X-Y-plane relative to the platform 115, in order to build one layer of a mold 116. Thereafter, the crafting medium 111 is deposited while the dual printhead is moving in an X-Y-plane relative to the platform 115 in order to fill the layer of the mold 116.

The crafting medium 111 is in the paste form. The layer of the crafting medium is required to be dried immediately. The crafting medium which is in the paste form includes 40 volume %-80 volume % metal/ceramic powder, 1 volume %-10 volume % organic base material, and 15 volume %-60 volume % water. In a preferred embodiment of the invention, the crafting medium consists of microscopic particles of metal, such as silver, gold, copper, tin, nickel, chromium, zinc, tungsten, cobalt, aluminium, molybdenum, boron, iron, titanium, vanadium, niobium, silicon, manganese, steel or alloys or combinations thereof, and also oxides from these metals, mixed with the binder organic base material and water. Also additional corrosion inhibitors, sintering aiding or lubrication additives in the range of 0.1-2 volume % can be added.

In another preferred embodiment, the powder is instead a ceramic powder such as silicon carbide, boron carbide, aluminum carbide, tungsten carbide, titanium carbide, tantalum carbide, silicon nitride, boron nitride, aluminum nitride, titanium nitride, zirconium nitride, steatite, forsterite, alumina, zircon beryllia, magnesia, mullite, cordierite, aluminum titanate and zirconia mixed with the binder organic base material and water. Also additional corrosion inhibitors, sintering aiding or lubrication additives in the range of 0.1-2% can be added.

Sintering aids such as Salts, gum rosin or pine rosin, isopropyl alcohol, Propylene glycol, Copper oxides, other metal oxides, low melting point metals or alkaline earth metals can be used. Lubricants aids such as essential oils, glycerin, zinc stearate or other stearates, carbon black, silica and ferrous oxide can be used. Corrosion inhibitor such as from the group consisting of the nitrate of lithium, sodium, potassium, calcium, magnesium, zinc, cobalt, iron, chromium, and copper, and the nitrite of lithium, sodium, potassium, calcium, magnesium, zinc can be used. The metal or ceramic powder particle size is in the range from 0.1-100 micrometers.

The water in the binder composition in the crafting medium is removed after deposition of each layer. The most of the water (60 to 90%) in the binder is removed immediately after deposition of each layer by use of the drying apparatus. This leaves a porous structure that still has some binder to keep the object rigid, but binder composite contents is small enough and object is porous enough to allow for sintering without separate debinding step in post processing. The system 100 includes the heating system or drying apparatus 119 which is connected on the printhead. The heating system is used for drying a paste of the crafting medium 111 by moving print head it is possible to after finishing each layer of the object (both mold and paste), the print head can repeatedly scan the printed layer and apply heat and air circulation to improve drying in a controlled way. The drying apparatus can consist of a radiating heater, and possibly an air circulation fan. This will enable better evenness in the drying and reduce risks for cracks and also reduces problems in the next steps.

Thereafter the dual printhead and the platform 115 are displaced in Z-direction from one another by a distance corresponding to the thickness of a single layer so that the next layer can be deposited. The first and second dispensing nozzles 107, 113 are used to deposit the fused filament and the crafting medium respectively and alternate the deposition on a layer by layer basis, in such a manner that the mold is alternately built and then filled with crafting medium for each single layer. When the deposition is achieved, the object 117 is embedded inside the mold 116. The mold 116 will thereafter be removed in order to release the object 117. That removal step is preferably achieved by heating the mold 116 to a temperature of approximately 200° C. until the mold building material is melted away from the object 117. If the object 117 is made of metal clay, the metal contained in the object 117 is thereafter sintered to obtain a pure metal object.

In an alternate embodiment of the present invention, the apparatus further includes heating means (not shown) for heating and melting the mold 116. Such heating means may consist of an insulated chamber, or an oven, inside which the mold 116 is exposed to heat energy in order to release the object 117.

A first supply of filament material used to build the mold. The supply of filament may comprise a rotatable spool on which the filament is wound. Such a filament material may be comprised of, but is not limited to, one or more of the following materials including various waxes, thermoplastic polymers, thermoset polymers, and combinations thereof. However, the primary modeling material preferably comprises an organic polymer with a reasonably low softening or melting point, e.g., acrylonitrile-butadiene-styrene (ABS) or Polylactic acid (PLA). The filament material is preferably a thermoplastic polymer that softens and liquifies for easy deposition and which rapidly cools and hardens to provide a suitable mold. Thermoplastic polymers useful for forming the mold from the filament material can include the following: poly(propylene), poly(styrene), poly(lactic acid) (PLA), acrylonitrilebutadiene-styrene (ABS), polycarbonate abs (PC-ABS), nylon, poly(carbonate), poly(phenyl sulfone), ultem, poly(ethylene), acrylic [poly(methyl methacrylate)], poly(benzimidazole), poly(ether sulfone), poly(etherether ketone), poly(etherimide), poly(phenylene oxide), poly(phenylene sulfide), poly(vinyl chloride), poly(vinyldiene fluoride), poly(acetal), poly(vinyl acetate), poly(vinyl butyrate), poly(vinyl alcohol), poly(4-hydroxystyrene), poly(vinyl formate), poly(vinyl stearate), poly(acrylamide), poly(caprolactone), chitosan and combinations thereof.

A second supply of crafting medium can be in paste form. Such a medium may consist of silicone, ceramic material or the like. The crafting medium can consist of very small particles of metal such as silver, gold, bronze, or copper mixed with binder.

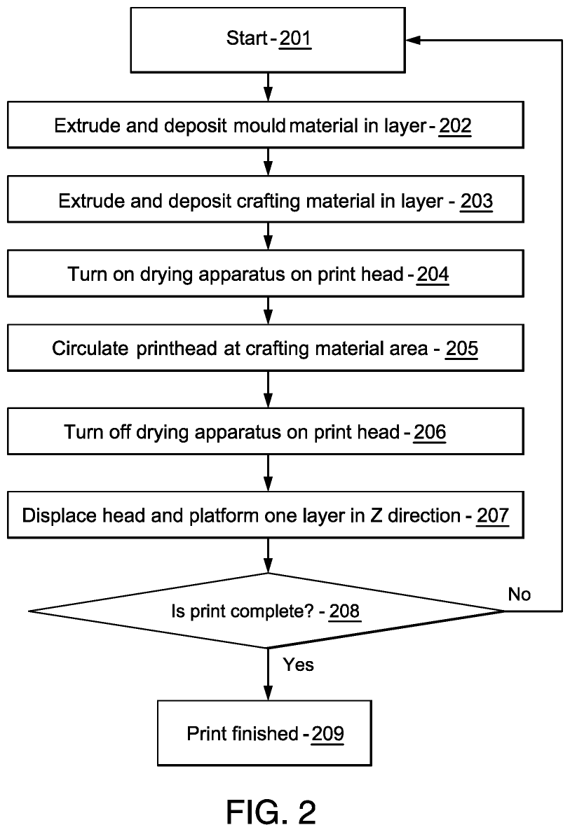

FIG. 2 illustrates by a flow chart an example of a method for drying a paste based crafting medium during three dimensional printing. The process “Start” at the block 201. At the block 202, extruding and depositing a mold material (filament material) in a layer form. In the block 202, there are several sub-steps involved (which are not depicted in the FIG. 2): such as providing a supply of mold building material in filament form; feeding the filament to enter one end of a flow passage of the first dispensing nozzle having a first discharge orifice on another end; heating the first dispensing nozzle to convert a leading portion of the filament therein to a flowable fluid; and dispensing the flowable fluid through the first discharge orifice to an object-supporting platform.

At the block 203, extruding and depositing a crafting medium in a layer form. In the block 203, there are several sub-steps involved: such as providing a supply of crafting medium in paste form; feeding the crafting medium to enter one end of a flow passage of the second dispensing nozzle having a second discharge orifice on another end; and during the dispensing step, operating the second dispensing nozzle for extruding the crafting medium on a layer.

At the block 204, turning on the drying apparatus or heating system 119. The heating system or drying apparatus is connected on the printhead. Then in the next step 205, circulate the printhead on the crafting medium layer. By circulating the printhead, the heating system is drying a paste of the crafting medium. By doing this drying is possible after finishing each layer of the object (both mold and paste), the print head can repeatedly scan the printed layer and apply heat and air circulation to improve drying in a controlled way. The layer of the crafting medium is required to be dried immediately. The crafting medium which is in the paste form includes 40 volume %-80 volume % metal/ceramic powder, 1 volume %-10 volume % binder organic base material, and 15 volume %-60 volume % water. The water-binder in the crafting medium is removed after deposition of each layer. During the three-dimensional printing around 60-90% of the water is removed during layer-by-layer deposition. This leaves a porous structure that still has some binder to keep the object rigid, but binder contents is small enough and object is porous enough to allow for sintering without separate debinding step in post processing. This will enable better evenness in the drying and reduce risks for cracks and also reduces problems in the next steps. Then “Turn off” the heating system or drying apparatus 110 at the block 206. Next at the block 207, thereafter the dual printhead and the platform are displaced in Z-direction from one another by a distance corresponding to the thickness of a single layer so that the next layer can be deposited. Next at the block 208, if the printing of the all layers, meaning that the crafted object and mold is complete then it moves to the next step, end of the process, block 208. Otherwise, the process starts again from block 201.

The present invention relates to a three-dimensional imaging process for making objects, preferably metal objects or ceramic objects, on a layer-by-layer basis under the control of a data processing system. Some of the process steps which are not included above in detail are: (a) providing a dual printhead including a first dispensing nozzle and a second dispensing nozzle; (b) during the dispensing step, moving the dual printhead and the object-supporting platform relative to one another in a plane defined by first and second directions and in a third direction orthogonal to said plane to form the flowable fluid into a three-dimensional hollow pattern having a molding cavity shaped in accordance with a predetermined three dimensional object; (c) by layer basis through the second discharge orifice onto the three-dimensional hollow pattern in order to gradually fill the molding cavity, thereby forming the predetermined three-dimensional object; and (d) removing the three-dimensional hollow pattern in order to release the predetermined three-dimensional object.

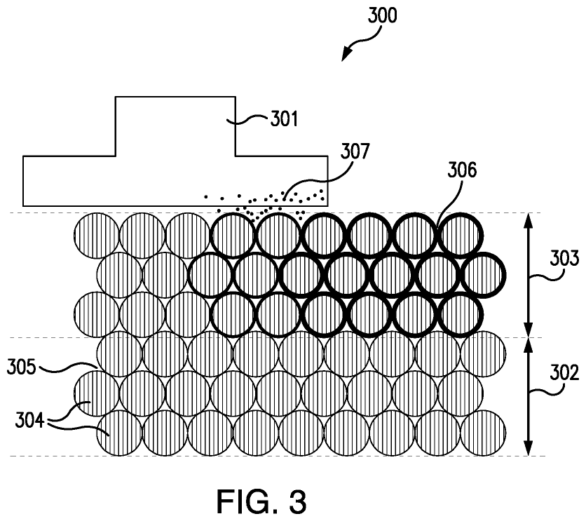

Embodiments of the present invention are further depicted in FIG. 3 which illustrates a structured layered during three-dimensional printing in accordance with the present invention. The structured layer 300 during three-dimensional printing is illustrated. The heating system or drying apparatus 301 which is connected on the printhead is used for removal of water component of the binder composition of the crafting medium after deposition of each layer. The first dried layer 302 is deposited earlier and which is also dried by heating system. The powder particles of the crafting medium are represented in FIG. 3 as 304. The dried layer 302 with binder composite having low water content 305 is depicted. The second layer 303 which is a newly deposited layer. This layer, before drying, has binder with high water content 306. The drying apparatus 301 when is rolls on the second layer 303, the debinding occurs by removing most of the water from the binder composite shown as vapor (dots) 307.

Crafting Medium

Although a wide variety of crafting media can be used with the methods and systems of the present invention, a particularly useful crafting medium contains a very low concentration of the binder organic base materials, such as starches, cellulose, cellulose derivatives, agar, etc., and around 15 to 60 volume % water. The binding organic base material content can be varied from 1 to 10 volume %. The binder can act as glue between the powder particles, and also as filler between the particles. The method of preparation of the three-dimensional object also includes the step of drying on a layer-by-layer basis. The drying is a continuous process in the present invention and can remove most of the water and/or other solvents or carriers from the binder composite material from each layer after depositing.

An exemplary crafting material useful herein comprises:

(i) from about 40% to about 80% by volume basis of a powder selected from metal powders, ceramic powders, and combinations, thereof;
(ii) from about 0.5% to about 10% by volume of a binder; and
(iii) from about 15% to about 60% by volume of an aqueous solvent.

An exemplary crafting material useful herein comprises:

(i) from about 40% to about 80% by volume basis of a powder selected from metal powders, ceramic powders, and combinations, thereof;
(ii) from about 0.5% to about 10% by volume of a binder; and
(iii) from about 15% to about 60% by volume of a non-aqueous solvent.

Another crafting material useful herein comprises,

(i) from about 60% to about 70% by volume basis of a powder;
(ii) from about 1% to about 5% by volume of a binder; and
(iii) from about 25% to about 35% by volume of an aqueous solvent.

Another crafting material useful herein comprises,

(i) from about 60% to about 70% by volume basis of a powder;
(ii) from about 1% to about 5% by volume of a binder; and
(iii) from about 25% to about 35% by volume of a non-aqueous solvent.

The solvent or carrier for the crafting material can be an aqueous solvent. Such an aqueous solvent can be solely or primarily water, or can comprise other solvent materials which are generally water miscible. In other embodiments, a nonaqueous solvent or mixtures of non-aqueous solvents can be employed. Such non-aqueous solvents can be selected from the group consisting of methanol, ethanol, 1-propanol, 2-propanol, acetone, acetaldehyde, ethyl acetate, C2-C4 diols, glycerol, acetonitrile, C4-alcohols, 2-ethoxyethanol, 2-ethyl hexanol, 1,2-dichloroethane, diisopropyl amine, isoamyl alcohol, propyl acetate, isopropyl acetate, and mixtures thereof. Also, contemplated are azeotropes.

Several materials can be used as the leaving component, i.e. the solvent or carrier, in the deposition technique involving continuous, layer-by-layer drying. One example of a departing component is water, with a vapor pressure of about 2.4 kPa. Higher vapor pressures, i.e. low boiling points, are in general preferred, as they will require less energy to drive away from the deposited part. However, including materials with vapor pressures which are very high as compared to water (acetaldehyde, for example) can in some instances cause difficulties with layer-to-layer and strand-to-strand bonding if the leaving component departs prior to the formation of a significant bond. In this case controlled drying, achieved via depression of the print temperature, can be employed during formation of the object. After formation of the object, the temperature (or other thermodynamic variable) can be changed to complete the removal of the leaving component.

Solvents used can be aqueous (e.g., water, and water with salts or surfactants), organic and primarily carbon based solvents, and organic solvents with halogen groups, fluorinated organic solvents, or mixtures of any of those aforementioned items. Mixtures of components may be chosen such that when the components leave the part, the components leave in a proportion identical or substantially similar to the proportion of the components in the deposited material.

In addition to the list provided below, materials such as dichloroethane, diiodoethane, fluorinated or chlorinated refrigerants, or degreaser materials as manufactured by DuPont (Operteron) or MicroCare (Tergo) can be used. Further, solvent drying specialty fluids added to liquids such as water or ethanol (and their mixtures), can be used. Such a solvent drying specialty fluid is Vertrel XP10 Solvent Drying Specialty fluid by MicroCare.

In the three-dimensional printing process, it is necessary to use binders to provide rigidity to the crafting medium of the object during fabrication. Different types of binding materials can be used in these three-dimensional printing processes. Organic binders, such as epoxy, polyurethane, agar-agar, starch, cellulosic materials, Agar (E406), Alginic acid (E400), Sodium alginate (E401), Carrageenan (E407), Gum arabic (E414), Gum ghatti, Gum tragacanth (E413), Karaya gum (E416), Guar gum (E412), Locust bean gum (E410), Beta-glucan, Chicle gum, Dammar gum, Glucomannan (E425), Mastic gum, Psyllium seed husks, Spruce gum, Tara gum (E417), Gellan gum (E418), Xanthan gum (E415), polyethylene oxide, polycarboxylic acids (polyacrylic acid), polycarboxylate ethers, polyvinyl alcohol, cellulose gum (Aquacel GSA and Aquacel GSH), hydroxymethyl cellulose, hydroxypropyl cellulose, Carboxymethyl cellulose, styrene-butadiene rubber, etc. can be used while Inorganic binders, such as magnesium oxides, magnesic, cement, sorel cement, salts, etc. are used.

The three-dimensional objects with a powder plus binder constitution for sintering can pose several problems. The binder can be difficult to remove because it needs to be dissolved or burned out after the object is finished. The binder can also be hazardous and or can require toxic substances to dissolve it away. While removing the binder there is a risk for developing cracks and deformities in the resulting object. Furthermore, methods of three-dimensional printing using clay or ceramic materials and preparing a mold are also well known in the prior art documents. Most of these prior art documents discusses the drying or heating of the mold or clay paste post processing. A major problem is cracking of the deposited object when the drying is carried out at the end of the full deposition processing. Cracks and unevenness can develop on the mold or on the object. The present invention is providing solution to solve these problems of cracks and unevenness of the object or the mold.

A solution to this cracking problem is achieved in the present patent application. This solution is achieved by providing a crafting medium comprising a metal or ceramic, binder organic base materials, and water. The crafting medium which is in the paste form includes 40 volume %-80 volume % metal/ceramic powder, 1 volume %-10 volume % organic base material, and 15 volume %-60 volume % water. The metal or ceramic powder particle size is in the range from 0.1-100 micrometers.

In further embodiments, the crafting medium comprises a thickening agent. A wide range of thickening agents can be selected. An example of such a thickening agent is carboxymethylcellulose. It is recognized that in some instances a material can be selected both for its binding and its thickening properties.

In another embodiment of the invention, the crafting medium comprises microscopic particles of a metal, such as silver, gold, copper, tin, nickel, chromium, zinc, tungsten, cobalt, aluminum, molybdenum, boron, iron, titanium, vanadium, niobium, silicon, manganese, steel or alloys or combinations thereof, and also oxides of these metals, mixed with the binder, organic base material, and water. Also, additional corrosion inhibitors or sintering aiding or lubrication additives, generally in the range of 0.1-2 volume %, can be added.

In another embodiment, the powder is instead a ceramic powder such as silicon carbide, boron carbide, aluminum carbide, tungsten carbide, titanium carbide, tantalum carbide, silicon nitride, boron nitride, aluminum nitride, titanium nitride, zirconium nitride, steatite, forsterite, alumina, zircon beryllia, magnesia, mullite, cordierite, aluminum titanate and zirconia mixed with the binder organic base material and water. Also additional corrosion inhibitors, sintering aiding or lubrication additives, generally in the range of 0.1-2 volume %, can be added.

In both these immediately foregoing embodiments, the binder organic base material can be polyurethane, agar-agar, starch, cellulosic materials, Agar (E406), Alginic acid (E400), Sodium alginate (E401), Carrageenan (E407), Gum arabic (E414), Gum ghatti, Gum tragacanth (E413), Karaya gum (E416), Guar gum (E412), Locust bean gum (E410), Beta-glucan, Chicle gum, Dammar gum, Glucomannan (E425), Mastic gum, Psyllium seed husks, Spruce gum, Tara gum (E417), Gellan gum (E418), Xanthan gum (E415), polyethylene oxide, polycarboxylic acids (polyacrylic acid), polycarboxylate ethers, polyvinyl alcohol, cellulose gum (Aquacel GSA and Aquacel GSH), hydroxymethyl cellulose, hydroxypropyl cellulose, Carboxymethyl cellulose, or combinations thereof.

Sintering aids such as salts, gum rosin or pine rosin, isopropyl alcohol, propylene glycol, copper oxides, other metal oxides, low melting point metals or alkaline earth metals can be used. Lubricants aids such as essential oils, glycerin, zinc stearate or other stearates, carbon black, silica and ferrous oxide can be used. Corrosion inhibitors such as those selected from the group consisting of nitrates of lithium, sodium, potassium, calcium, magnesium, zinc, cobalt, iron, chromium, and copper, and the nitrite of lithium, sodium, potassium, calcium, magnesium, zinc, can be used.

With the compositions and processes of the present invention, substantially all of the moisture, i.e. the water, and other solvent or carrier components for the binder of the crafting medium is removed immediately after deposition of each layer by use of the drying means or apparatus. By “substantially all of the moisture” is meant that at least about 90% by weight, and in further embodiments at least about 95% by weight, and yet in further embodiments at least about 99% by weight of the water and other solvent or carrier components are removed. This novel method of three-dimensional object building does not require the use of a post-processing debinding step. Furthermore, the present invention also provides a system for improved drying in a controlled manner of a paste based crafting medium during three-dimensional printing and methods thereof. The drying means or apparatus can take the forms described above. These means make drying possible after printing each layer of the object (both mold and paste).

### EXAMPLES

The following examples further described and demonstrate embodiments within the scope of the present invention. The Examples are given solely for purpose of illustration and are not to be construed as limitations of the present invention, as many variations thereof are possible without departing from the spirit and scope of the invention.

### Example 1: Crafting Medium and Process for Making

A crafting medium comprising the following components was prepared. The components are each on a volume % basis.

Stainless steel powder 17-4: 62%

Distilled water: 32%

Arrow root powder: 4%

Xanthan gum 1%

Polycarboxylate ether 1

A premix of the water and arrow root is prepared by heated to 80° C. with stirring. The premix is then cooled to room temperature. A separate premix of xanthan gum and the polycarboxylate ether is made by combining them with stirring to form a thick paste. Next, the stainless steel powder and the xanthan gum premix are added to the arrow root premix and combined using a mechanical stirrer.

The resulting paste is useful for three-dimensional printing. The paste can be printed on a line-by-line and layer-by-layer basis in conjunction with a mold layer. Each deposited paste layer is dried according to the present invention. The resulting three-dimensional object is then subsequently debound and then sintered to provide the stainless steel three-dimensional object.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

### INCORPORATION BY REFERENCE

The entire disclosure of each of the patent documents, including certificates of correction, patent application documents, scientific articles, governmental reports, websites, and other references referred to herein is incorporated by reference herein in its entirety for all purposes. In case of a conflict in terminology, the present specification controls.

### EQUIVALENTS

The invention can be embodied in other specific forms without departing from the spirit or essential characteristics thereof. The foregoing embodiments are to be considered in all respects illustrative rather than limiting on the invention described herein. In the various embodiments of the methods and systems of the present invention, where the term comprises is used with respect to the recited steps of the methods or components of the compositions, it is also contemplated that the methods and compositions consist essentially of, or consist of, the recited steps or components. Furthermore, it should be understood that the order of steps or order for performing certain actions is immaterial so long as the invention remains operable. Moreover, two or more steps or actions can be conducted simultaneously.

In the specification, the singular forms also include the plural forms, unless the context clearly dictates otherwise. Unless defined otherwise, all technical and scientific terms used herein have the same meaning as commonly understood by one of ordinary skill in the art to which this invention belongs. In the case of conflict, the present specification will control.

Furthermore, it should be recognized that in certain instances a composition can be described as being composed of the components prior to mixing, or prior to a further processing step such as drying, binder removal, heating, sintering, etc. It is recognized that certain components can further react or be transformed into new materials.

All percentages and ratios used herein are on a volume (volume/volume) or weight (weight/weight) basis as shown, or otherwise indicated.

1. A crafting medium for three-dimensional printing of a metallic or ceramic object comprising:
(a) from about 40% to about 80% by volume basis of a powder selected from the group consisting of metal powders, ceramic powders, and combinations, thereof;
(b) from about 0.5% to about 10% by volume of a binder; and
(c) from about 15% to about 60% by volume of an aqueous solvent.

2. The crafting medium according to claim 1 wherein the aqueous solvent is selected from the group consisting of water, or water in combination with one or more water-miscible solvents.

3. The crafting medium according to claim 1 wherein the powder has a particle size from about 0.1 to about 100 microns.

4. The crafting medium according to claim 2 wherein said aqueous solvent is selected from the group consisting of water, or water in combination with one or more non-aqueous solvents selected from the group consisting of methanol, ethanol, 1-propanol, 2-propanol, acetone, acetaldehyde, ethyl acetate, C2-C4 diols, glycerol, acetonitrile, C4-alcohols, 2-ethoxyethanol, 2-ethyl hexanol, 1,2-dichloroethane, diisopropyl amine, isoamyl alcohol, propyl acetate, isopropyl acetate, and mixtures thereof.

5. The crafting medium according to claim 1 wherein said metal powder is selected from the group consisting of silver, gold, copper, tin, nickel, chromium, zinc, tungsten, cobalt, aluminum, molybdenum, boron, iron, titanium, vanadium, niobium, silicon, manganese, steel, metal alloys or combinations thereof.

6. The crafting medium according to claim 1 wherein said ceramic powder is selected from the group consisting of silicon carbide, boron carbide, aluminum carbide, tungsten carbide, titanium carbide, tantalum carbide, silicon nitride, boron nitride, aluminum nitride, titanium nitride, zirconium nitride, steatite, forsterite, alumina, zircon beryllia, magnesia, mullite, cordierite, aluminum titanate, zirconia, and combinations thereof

7. The crafting medium according to claim 1 wherein the binder is selected from the group consisting of organic binders, inorganic binders, and combinations thereof.

8. The crafting medium according to claim 7 wherein the in organic binder is selected from the group consisting of epoxy, polyurethane, agar-agar, starch, cellulosic materials, arrow root, Agar (E406), Alginic acid (E400), Sodium alginate (E401), Carrageenan (E407), Gum arabic (E414), Gum ghatti, Gum tragacanth (E413), Karaya gum (E416), Guar gum (E412), Locust bean gum (E410), Beta-glucan, Chicle gum, Dammar gum, Glucomannan (E425), Mastic gum, Psyllium seed husks, Spruce gum, Tara gum (E417), Gellan gum (E418), Xanthan gum (E415), polyethylene oxide, polycarboxylic acids (polyacrylic acid), polycarboxylate ethers, polyvinyl alcohol, cellulose gum (Aquacel GSA and Aquacel GSH), hydroxymethyl cellulose, hydroxypropyl cellulose, carboxymethyl cellulose, styrene-butadiene rubber, and combinations thereof.

9. The crafting medium according to claim 7 wherein the inorganic binder is selected from the group consisting of magnesium oxide, magnesic, cement, sorel cement, inorganic salts, and combinations thereof.

10. The crafting medium according to claim 1 comprising:
(a) from about 60% to about 70% by volume basis of a powder;
(b) from about 1% to about 5% by volume of a binder; and
(c) from about 25% to about 35% by volume of an aqueous solvent.

11. The crafting medium according to claim 1 further comprising from about 0.1% to about 2% by volume of one or more additives selected from the group consisting of corrosion inhibitors, sintering aids, viscosity modifers, and lubricants.

12. The crafting medium according to claim 11 wherein said corrosion inhibitor is selected from the group consisting of lithium nitrate, sodium nitrate, potassium nitrate, calcium nitrate, magnesium nitrate, zinc nitrate, cobalt nitrate, iron nitrate, chromium nitrate, copper nitrate, lithium nitrite, sodium nitrite, potassium nitrite, calcium nitrite, magnesium nitrite, zinc nitrite, and mixtures thereof.

13. The crafting medium according to claim 11 wherein said sintering aid is selected from the group consisting of salts, gum rosin, pine rosin, isopropyl alcohol, propylene glycol, metal oxides, low-melting point metals, alkaline earth metals, and mixtures thereof.

14. The crafting medium according to claim 11 wherein said lubricant is selected from the group consisting of essential oils, glycerin, metal stearate salts, carbon black, silica, ferric oxides, and combinations thereof.

15. (canceled)

16. An extrusion layer for three-dimensional printing of a metallic or ceramic object comprising:
(I) a crafting medium, comprising:
(a) from about 40% to about 80% by volume basis of a powder selected from the group consisting of metal powders, ceramic powders, and combinations, thereof;
(b) from about 0.5% to about 10% by volume of a binder; and
(c) from about 15% to about 60% by volume of an aqueous solvent;
and
(II) a mold layer for containing said crafting medium, comprising a polymeric molding material;
wherein said mold layer substantially contains said crafting medium.

17. The extrusion layer according to claim 16 wherein said polymeric molding material is selected from the group consisting of poly(propylene), poly(styrene), poly(lactic acid) (PLA), acrylonitrilebutadiene-styrene (ABS), polycarbonate abs (PC-ABS), nylon, poly(carbonate), poly(phenyl sulfone), ultem, poly(ethylene), acrylic [poly(methyl methacrylate)], poly(benzimidazole), poly(ether sulfone), poly(etherether ketone), poly(etherimide), poly(phenylene oxide), poly(phenylene sulfide), poly(vinyl chloride), poly(vinyldiene fluoride), poly(acetal), poly(vinyl acetate), poly(vinyl butyrate), poly(vinyl alcohol), poly(4-hydroxystyrene), poly(vinyl formate), poly(vinyl stearate), poly(acrylamide), poly(caprolactone), chitosan and combinations thereof.

18. The extrusion layer according to claim 16 prior to sintering.

19. A method of making a crafting medium for three-dimensional printing of a metallic or ceramic object comprising:
(a) from about 40% to about 80% by volume basis of a powder selected from the group consisting of metal powders, ceramic powders, and combinations, thereof;
(b) from about 0.5% to about 10% by volume of a binder; and
(c) from about 15% to about 60% by volume of an aqueous solvent, comprising the steps of:
(i) dissolving the binder in the aqueous solvent with stirring and heating to obtain a solution; and
(ii) mixing the powder with the solution obtained from step (i) with stirring to yield a crafting medium suitable for three-dimensional printing of a metallic or ceramic object.

20. The method according to claim 19 wherein said crafting medium comprises
(a) from about 60% to about 70% by volume basis of a powder;
(b) from about 1% to about 5% by volume of a binder; and
(c) from about 25% to about 35% by volume of an aqueous solvent.

21. A crafting medium for three-dimensional printing of a metallic or ceramic object comprising:
(a) from about 40% to about 80% by volume basis of a powder selected from the group consisting of metal powders, ceramic powders, and combinations, thereof;
(b) from about 0.5% to about 10% by volume of a binder; and
(c) from about 15% to about 60% by volume of a non-aqueous solvent.

22. The crafting medium according to claim 21 wherein said non-aqueous solvent is selected from the group consisting of methanol, ethanol, 1-propanol, 2-propanol, acetone, acetaldehyde, ethyl acetate, C2-C4 diols, glycerol, acetonitrile, C4-alcohols, 2-ethoxyethanol, 2-ethyl hexanol, 1,2-dichloroethane, diisopropyl amine, isoamyl alcohol, propyl acetate, isopropyl acetate, and mixtures thereof.
